(19) United States
(12) Patent Application Publication
(10) Pub. No.: US 2013/0222833 A1
(43) Pub. Date: Aug. 29, 2013

(54) IMAGE FORMING APPARATUS, IMAGE FORMING APPARATUS CONTROL METHOD, AND STORAGE MEDIUM

(71) Applicant: CANON KABUSHIKI KAISHA, (US)

(72) Inventor: Yasuhiko Hirano, Yokohama-shi (JP)

(73) Assignee: CANON KABUSHIKI KAISHA, Tokyo (JP)

(21) Appl. No.: 13/776,935

(22) Filed: Feb. 26, 2013

(30) Foreign Application Priority Data
Feb. 28, 2012 (JP) 2012-041674

(51) Int. Cl. H04N 1/00

(52) U.S. Cl. CPC H04N 1/00891
USPC 358/1.13

(57) ABSTRACT

An image forming apparatus including a plurality of interfaces configured to receive external inputs via a network, a display unit configured to display a screen for selecting an interface to be used in a power saving state from among the plurality of interfaces, and a power supply unit configured to supply a power to the interface that is selected on the screen and not to supply a power to a interface that is not selected on the screen in a case where the image forming apparatus enters the power saving state.

### BACKGROUND OF THE INVENTION

1. Field of the Invention

The present invention relates to an image forming apparatus such as a multifunction peripheral and a printer, for example. More particularly, the present invention relates to a power reduction technology for an image forming apparatus.

2. Description of the Related Art

Conventionally, in an image forming apparatus, when there has been no operation requests for a fixed period of time or more, a control is performed to make the image forming apparatus enter into state in which power consumption is reduced, i.e., a sleep state. An example of a method to realize this is to control so that a clock supply to a function module, such as a printing unit, that operates during normal operation but does not operate during sleep, is stopped.

However, in recent image forming apparatuses, there is an increasing variety of wake-up trigger detection units that detect wake up triggers for making the apparatus wake up from sleep back into a normal state, so that for a sleep state in which all of these wake-up trigger detection units are operating, there is little power reduction effect.

To deal with this situation, Japanese Patent Application Laid-Open No. 2010-218120, for example, discusses a technology in which in addition to function modules, such as a printing unit, that do not operate during sleep, a wake-up trigger detection unit (e.g., a switch, opening/closing of a pressing plate, document setting, a network) is selected, and the power supply is also stopped for other wake-up trigger detection units.

However, in the method discussed in Japanese Patent Application Laid-Open No. 2010-218120, nothing is discussed about an apparatus that includes a plurality of network interfaces. Therefore, based on the method discussed in Japanese Patent Application Laid-Open No. 2010-218120, when a network is selected to be invalidated, the device can no longer be woken up via the network. In contrast, if a unit other than the network is selected to be invalidated, although the amount of power consumed by the wake-up trigger units other than the network can be suppressed, the amount of power consumed by the network increases.

### SUMMARY OF THE INVENTION

According to an aspect of the present invention, an image forming apparatus configured to enter a first power state in which power is supplied to a part of the image forming apparatus and a second power state in which power is not supplied to the part of the image forming apparatus, the image forming apparatus includes a plurality of interfaces configured to receive external inputs via a network a display unit configured to display a screen for selecting an interface that becomes effective in a case where the image forming apparatus is in the second power state, from among the plurality of interfaces, and a power supply unit, in a case where the image forming apparatus is in the second power state, configured to supply power to an interface that has been selected on the screen displayed by the display unit and configured not to supply a power to an interface that has not been selected on the screen.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a hardware configuration of an image forming apparatus according to a first exemplary embodiment of the present invention.

FIG. 2 is a flowchart illustrating an overall power saving operation in an image forming apparatus 100.

FIG. 3 is a flowchart illustrating an example of a setting operation of a standby I/F during sleep selection illustrated in step S201 of FIG. 2.

FIG. 4 is a flowchart illustrating an example of a sleep entry control operation illustrated in step S203 of FIG. 2.

FIGS. 5A to 5C illustrate an example of a UI screen that shows a setting operation of a sleep standby I/F during sleep selection.

FIG. 6 is a flowchart illustrating an example of a sleep wake up control operation illustrated in step S205 of FIG. 2.

FIG. 7 illustrates a clock supply state to each unit in an image forming apparatus 100.

### DESCRIPTION OF THE EMBODIMENTS

Various exemplary embodiments, features, and aspects of the invention will be described in detail below with reference to the drawings.

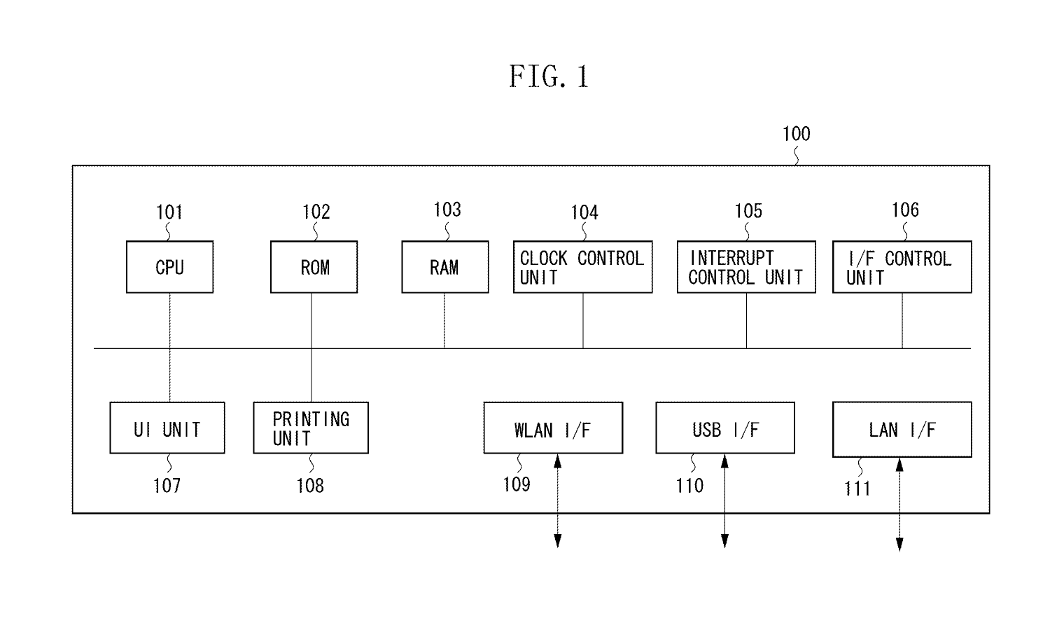

FIG. 1 is a block diagram illustrating a hardware configuration of an image forming apparatus according to a first exemplary embodiment of the present invention. In FIG. 1, an image forming apparatus 100 includes a central processing unit (CPU) 101, a read-only memory (ROM) 102, a random access memory (RAM) 103, a clock control unit 104, an interrupt control unit 105, an interface (I/F) control unit 106, a user interface (UI) unit 107, a printing unit 108, a wireless local area network (WLAN) I/F 109, a universal serial bus (USB) I/F 110, and a local area network (LAN) I/F 111.

The CPU 101 performs control of each unit in the image forming apparatus 100. The ROM 102 stores image forming apparatus 100 control programs. The RAM 103 is used as a control program execution area, a work data area for image processing, and an output data storage area.

The clock control unit 104 controls the supply and stoppage of a clock to each unit in the image forming apparatus 100. The interrupt control unit 105 controls the validation and invalidation of interruptions by each unit in the image forming apparatus 100. For example, when entering sleep, the interrupt control unit 105 controls so that an interruption from the USB I/F 110 is invalidated and not transmitted to the CPU 101. On the other hand, the interrupt control unit 105 controls so that an interruption from the LAN I/F 111 is validated, and thus is transmitted to the CPU 101.

The I/F control unit 106 controls the image forming apparatus 100 interfaces (I/Fs). The UI unit 107 is a user interface such as a panel. The printing unit 108 performs printing. The WLAN I/F 109 is an interface for performing connection with a wireless LAN. The USB I/F 110 is an interface for performing connection with a USB device. The LAN I/F 111 is an interface for performing connection with a wired LAN. In other words, a plurality of interfaces (the WLAN I/F 109, the USB I/F 110, and the LAN I/F 111) that receive external inputs is connected to the image forming apparatus 100.

The image forming apparatus 100 can enter a sleep state (power saving state) by limiting the clock supply with the clock control unit 104. Based on this configuration, there is no need to provide additional circuits for power control to control the power supply to each module, so that an increase in costs can be suppressed. Below, the clock supply state of each unit in the image forming apparatus 100 for each state of the image forming apparatus 100 (standby state, sleep state, power off state) will be described.

### Clock Supply State

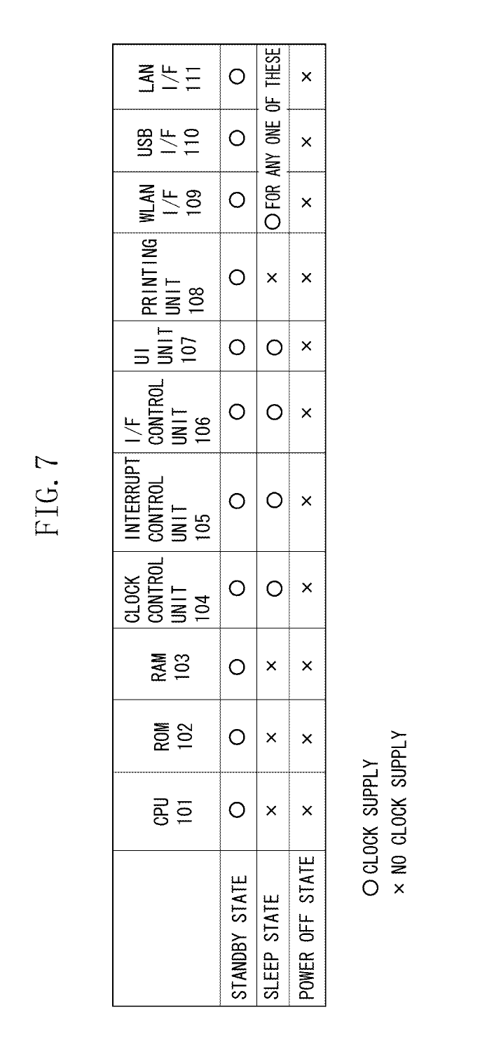

FIG. 7 illustrates a clock supply state to each unit in the image forming apparatus 100.

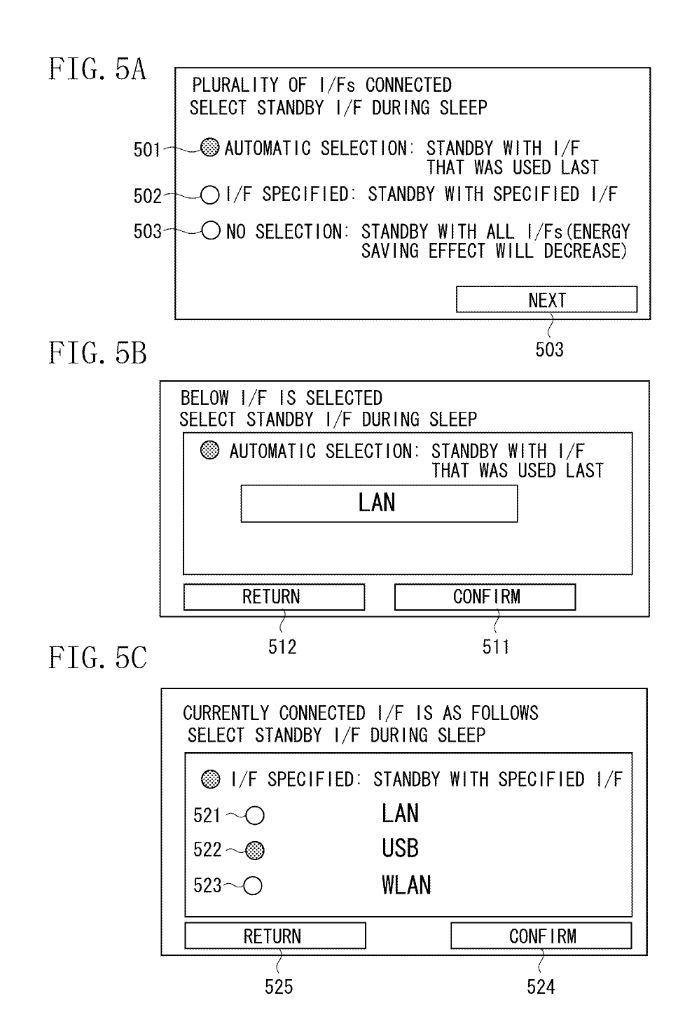

As illustrated in FIG. 7, in a standby state, a clock is supplied to each unit in the image forming apparatus 100. In a sleep state (power saving state), a clock is supplied to the clock control unit 104, the interrupt control unit 105, the I/F control unit 106, and the UI unit 107, as well as to any one of the WLAN I/F 109, the USB I/F 110, and the LAN I/F 111 that is selected as a standby I/F during sleep. If a standby I/F during sleep is not selected (corresponding to the “No selection: Standby with all I/Fs” 503 in the screen illustrated in FIG. 5A), a clock is supplied to all of the WLAN I/F 109, the USB I/F 110, and the LAN I/F 111 even in a sleep state. In a power off state, a clock is not supplied to any of the units in the image forming apparatus 100.

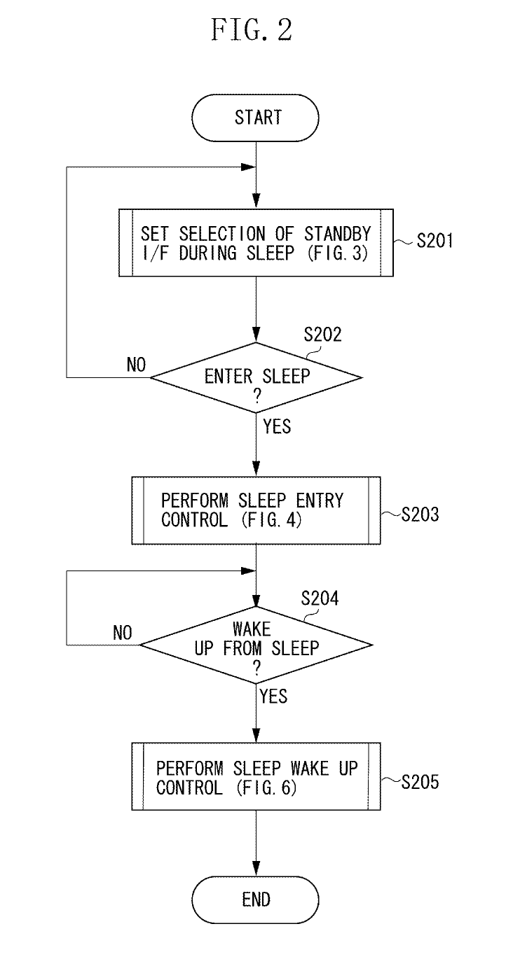

A power reduction operation (entry into sleep and wake up from sleep) in the image forming apparatus 100 will now be described with reference to FIGS. 2 to 6.

### Overall Operation

FIG. 2 is a flowchart illustrating an overall power reduction operation in the image forming apparatus 100. The operation procedure illustrated in this flowchart is realized by the CPU 101 included in the image forming apparatus 100 executing a control program that is computer-readably recorded in the ROM 102 or expanded in the RAM 103 of the image forming apparatus 100.

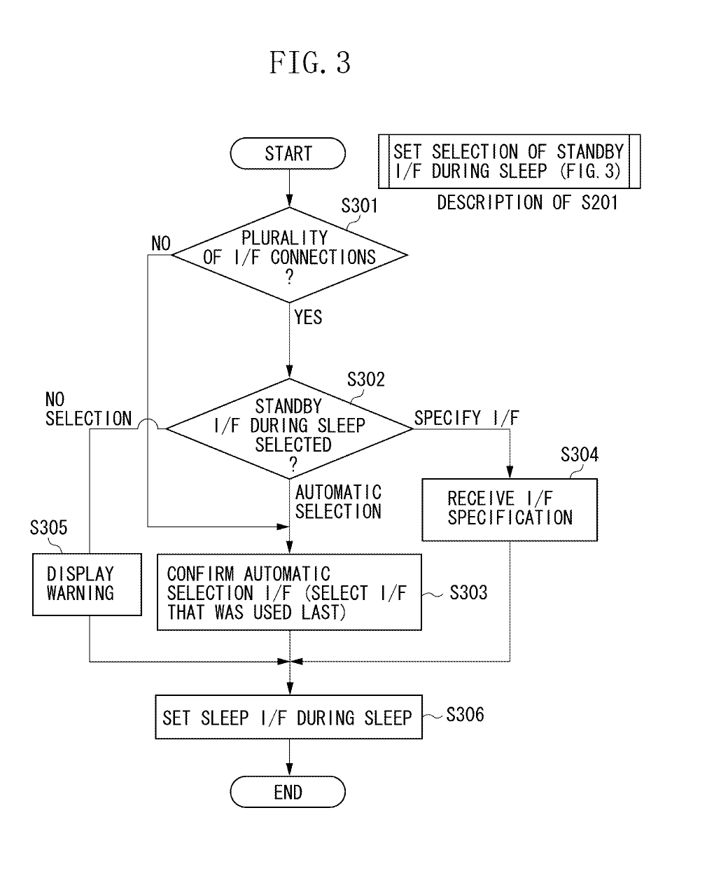

First, in step S201, the CPU 101 receives a setting from the user and preliminary performs selection setting of a standby I/F during sleep (this is illustrated in detail in FIG. 3).

The selection setting processing of standby I/F during sleep performed in step S201 is a step that is executed by the CPU 101 when standby I/F during sleep selection setting has not yet been set, or when instruction for resetting the standby I/F during sleep selection setting is issued. If the standby I/F during sleep selection setting has already been set, and no reset instruction has been issued, the CPU 101 skips the processing performed in step S201, and the processing proceeds to step S202.

In step S202, the CPU 101 determines whether to enter into sleep based on a setting condition, such as the absence of an operation for a predetermined duration. If it is determined not to enter sleep (NO in step S202), the determination performed in step S202 is continued. On the other hand, if it is determined to enter sleep (YES in step S202), the CPU 101 proceeds to step S203.

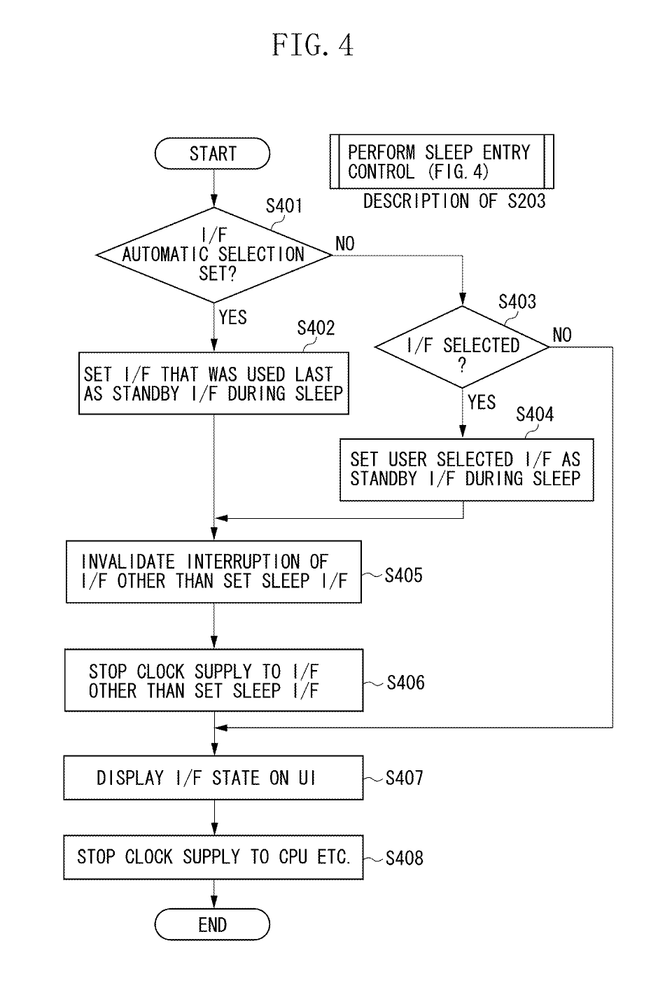

In step S203, the CPU 101 performs a sleep entry control (illustrated in detail in FIG. 4), and as a result the image forming apparatus 100 enters a sleep state. As illustrated in FIG. 7, a clock is supplied to only the clock control unit 104, the interrupt control unit 105, the I/F control unit 106, the UI unit 107, and the interface (any one of the WLAN I/F 109, the USB I/F 110, and the LAN I/F 111) selected as the standby I/F during sleep.

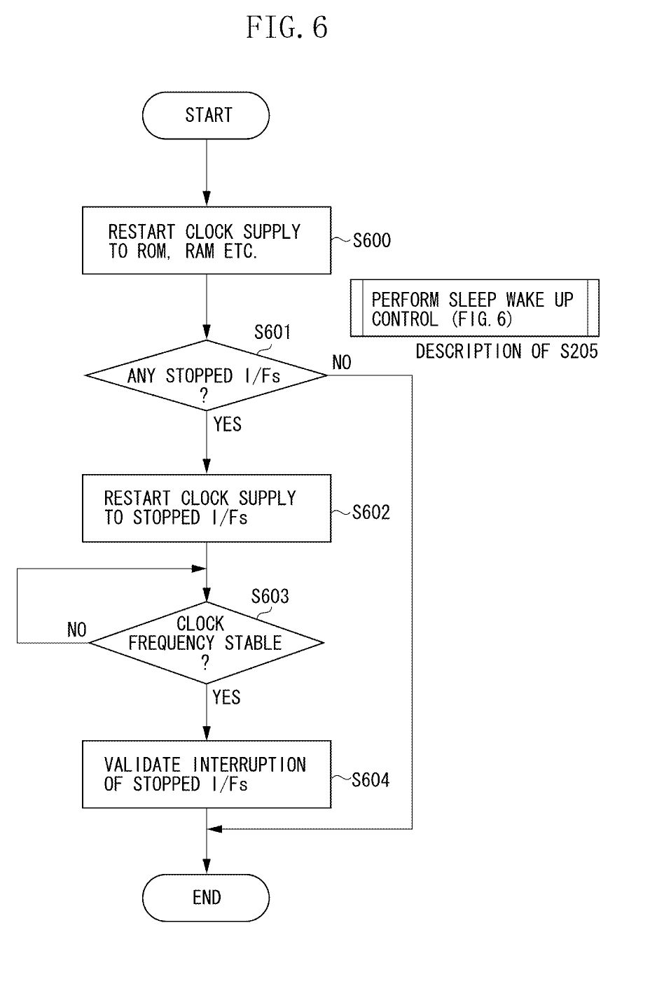

In a sleep state, if the interface (standby I/F during sleep) (i.e., any one of the WLAN I/F 109, the USB I/F 110, and the LAN I/F 111) to which a clock is supplied is accessed (e.g., data is received), the I/F control unit 106 detects this access. Then, an interruption from the standby I/F during sleep is input to the interrupt control unit 105, and the interrupt control unit 105 interrupts the CPU 101 (interruption by a standby I/F during sleep is validated). At this stage, the interrupt control unit 105 also interrupts the clock control unit 104. The clock control unit 104, which has received this interruption, restarts the clock supply to the CPU 101. The CPU 101, which received the interruption from the interrupt control unit 105 and to which the clock supply from the clock control unit 104 has been restarted, restarts operation and determines that wake up from the sleep state has been performed (YES in step S204). Then, the processing proceeds to step S205. In step S205, the CPU 101 performs a sleep wake up control (illustrated in detail in FIG. 6).

### Setting Operation of Standby I/F During Sleep Selection

Next, the setting operation of a standby I/F during sleep selection illustrated in step S201 of FIG. 2 will be described with reference to FIG. 3 and FIGS. 5A and 5B.

FIG. 3 is a flowchart illustrating an example of the setting operation standby I/F during sleep selection illustrated in step S201 of FIG. 2. The operation procedure illustrated in this flowchart is realized by the CPU 101 included in the image forming apparatus 100 executing a control program that is computer-readably recorded in the ROM 102 or expanded in the RAM 103 of the image forming apparatus 100.

FIGS. 5A and 5B illustrate an example of a UI screen that shows a setting operation of a standby I/F during sleep selection.

In step S301, the CPU 101 detects the interfaces that are connected with the I/F control unit 106, and determines whether a plurality of interfaces is connected. If it is determined that a plurality of interfaces is not connected (NO in step S301), the CPU 101 proceeds directly to step S303. On the other hand, if it is determined that a plurality of interfaces is connected (YES in step S301), the CPU 101 proceeds to step S302.

In step S302, the CPU 101 displays the standby I/F during sleep selection screen illustrated in FIG. 5A on a display unit of the UI unit 107 to prompt selection of the I/F to be on standby during sleep based on a user input from the UI unit 107. The processing then takes a different path based on the selection result.

In FIG. 5A, when the user selects “automatic selection” (501) and then presses (touches) the “next” button 504, the CPU 101 determines that “automatic selection” is selected as the standby I/F during sleep selection (determines in step S302 that “automatic selection” is selected), and the CPU 101 proceeds to step S303.

In step S303, the CPU 101 displays the sleep standby I/F selection screen illustrated in FIG. 5B on the display unit of the UI unit 107 to notify the user of the interface that will be automatically selected at the current point. If the CPU 101 detects that a confirm button 511 has been pressed (touched), the CPU 101 stores information indicating that “automatic selection” is selected in the RAM 103 as selection information about the I/F to be on standby during sleep, and the CPU 101 then proceeds to step S306. The I/F that is used last is detected by the I/F control unit 106 when it is used, and is stored in the I/F control unit 106. If the return button 512 is pressed (touched), the processing returns to step S302 (this operation is not illustrated).

Further, in FIG. 5A, when the user selects “specify I/F” (502) and then presses (touches) the “next” button 504, the CPU 101 determines that “specify I/F” is selected as the standby I/F during sleep selection (determines in step S302 that “specify I/F” is selected), and the CPU 101 proceeds to step S304.

In step S304, the CPU 101 displays the standby I/F during sleep selection screen illustrated in FIG. 5C on the display unit of the UI unit 107 to prompt the user to specify the I/F to be on standby during sleep. Then, when the CPU 101 detects that any one of LAN (521), USB (522), or WLAN (523) has been selected and the confirm button 524 has been pressed (touched) by the user, the CPU 101 stores information indicating the interface selected by buttons 521 to 523 in the RAM 103 as selection information about the I/F to be on standby during sleep, and the CPU 101 then proceeds to step S306. If the return button 525 is pressed (touched), the processing returns to step S302 (this operation is not illustrated).

In addition, in FIG. 5A, when the user selects “no selection” 503 and then presses (touches) the “next” button 504, the CPU 101 determines that “no selection” is selected as the standby I/F during sleep selection (determines in step S302 that “no selection” is selected), and the CPU 101 proceeds to step S305.

In step S305, the CPU 101 displays a (not illustrated) screen on the display unit of the UI unit 107 warning that there is little energy saving (power saving) effect. Then, when the CPU 101 detects that a confirm button (not illustrated) has been pressed (touched), the CPU 101 stores information indicating that “no selection” is selected in the RAM 103 as selection information about the I/F to be on standby during sleep, and the CPU 101 then proceeds to step S306. If a return button (not illustrated) on this warning screen is pressed (touched), the processing returns to step S302 (this operation is not illustrated).

In step S306, the CPU 101 sets the I/F selection information about the I/F to be on standby during sleep that is stored in the RAM 103 in the I/F control unit 106 (stores this information in the I/F control unit 106), and the CPU 101 returns the processing to the flowchart illustrated in FIG. 2.

### Control Operation of Sleep Entry

Next, the control operation of sleep entry illustrated in step S203 of FIG. 2 will be described with reference to FIG. 4. FIG. 4 is a flowchart illustrating an example of the control operation of sleep entry illustrated in step S203 of FIG. 2. The operation procedure illustrated in this flowchart is realized by the CPU 101 included in the image forming apparatus 100 executing a control program that is computer-readably recorded in the ROM 102 or expanded in the RAM 103 of the image forming apparatus 100.

In step S401, the CPU 101 determines whether the selection information about the I/F to be on standby during sleep set in the I/F control unit 106 is “automatic selection”. If it is determined that the selection information about the I/F to be on standby during sleep is “automatic selection” (YES in step S401), the processing proceeds to step S402. In step S402, the CPU 101 sets (determines) the I/F that is used last, which is detected and stored by the I/F control unit 106, as the standby I/F during sleep, and the CPU 101 proceeds to step S405.

If it is determined that the selection information about the I/F to be on standby during sleep is not “automatic selection” (NO in step S401), the processing proceeds to step S403. In step S403, the CPU 101 determines whether an I/F to be on standby during sleep has been selected. Specifically, the CPU 101 determines whether the selection information about the I/F to be on standby during sleep set in the I/F control unit 106 is information indicating any of the interfaces (WLAN I/F 109, USB I/F 110, and LAN I/F 111).

If it is determined that an I/F to be on standby during sleep has been selected (YES in step S403), the CPU 101 proceeds to step S404. In step S404, the CPU 101 sets (determines) the I/F selected by the user (i.e., the selection information set in the I/F control unit 106) as the standby I/F during sleep, and the CPU 101 proceeds to step S405.

On the other hand, if it is determined that an I/F to be on standby during sleep has not been selected (NO in step S403), the CPU 101 proceeds to step S407.

Next, in steps S405 and S406, the CPU 101 stops operation of the I/Fs other than the I/F set as the standby I/F during sleep. More specifically, in step S405, the CPU 101 invalidates interruption by the I/Fs other than the I/F set as the standby I/F during sleep with the interrupt control unit 105. In addition, in step S406, the CPU 101 stops the clock supply to the I/Fs other than the I/F set as the standby I/F during sleep with the clock control unit 104.

For example, if the standby I/F during sleep is set as the LAN I/F 111, in step S405, the CPU 101 invalidates interruption by the I/Fs other than the LAN I/F 111 (i.e., the USB I/F 110 and the WLAN I/F 109) with the interrupt control unit 105. Further, in step S406, the CPU 101 stops the clock supply to the I/Fs other than the LAN I/F 111 (i.e., the USB I/F 110 and the WLAN I/F 109) with the clock control unit 104.

Next, in step S407, the CPU 101 displays the I/F to be on standby during sleep (the standby I/F during sleep) on the UI unit 107, and notifies the user. For example, the CPU 101 displays a message, such as “Entering a sleep (power saving) state. The LAN I/F can be used even in a sleep state.” on the display unit of the UI unit 107.

Next, in step S408, the CPU 101 instructs the clock control unit 104 to stop clock supply to the CPU 101, the ROM 102, the RAM. 103, and the printing unit 108. Consequently, the image forming apparatus 100 enters a sleep state.

Thus, even when a plurality of interfaces is connected, power consumption during sleep can be reduced by entering sleep while keeping only an interface selected and set by the user as the standby interface during sleep and stopping operation of the other interfaces. Further, power consumption during sleep can be reduced by entering sleep while keeping only the interface last used by the user and stopping operation of the other interfaces.

Wake Up Control Operation from Sleep

Next, the sleep wake up control operation illustrated in step S205 of FIG. 2 will be described with reference to FIG. 6. FIG. 6 is a flowchart illustrating an example of the sleep wake up control operation illustrated in step S205 of FIG. 2. The operation procedure illustrated in this flowchart is realized by the CPU 101 included in the image forming apparatus 100 executing a control program that is computer-readably recorded in the ROM 102 or expanded in the RAM 103 of the image forming apparatus 100.

First, in step S600, the CPU 101 instructs the clock control unit 104 to restart the clock supply to the ROM 102, the RAM 103, the UI unit 107, and the printing unit 108. Next, in step S601, the CPU 101 determines whether there is an I/F that has stopped operation with the I/F control unit 106.

If it is determined that there are no I/Fs that have stopped operation with the I/F control unit 106 (NO in step S601), the CPU 101 finishes the sleep wake up control operation. On the other hand, if it is determined that there is an I/F that has stopped operation (YES in step S601), the CPU 101 proceeds to step S602.

In step S602, the CPU 101 restarts the clock supply to the I/F that has stopped operation (operation-stopped I/F) with the clock control unit 104. For example, as described above, if the USB I/F 110 and the WLAN I/F 109 are stopped, the CPU 101 restarts the clock supply to the USB I/F 110 and the WLAN I/F 109 with the clock control unit 104.

Next, in step S603, after waiting for a period (a predetermined time) in which the clock frequency stabilizes to elapse (YES in step S603), in step S604, the CPU 101 validates interruption by the operation-stopped I/Fs (the I/Fs to which the clock supply has been restarted in step S602) with the interrupt control unit 105. In the above example, in step S604, the CPU 101 validates interruption by the USB I/F 110 and the WLAN I/F 109 with the interrupt control unit 105. Then, the CPU 101 finishes the sleep wake up control operation. Consequently, the image forming apparatus 100 returns to a standby state.

The present invention may also be applied by limiting the interface to only a network interface. For example, the present invention may be configured so that, among the plurality of interfaces that receive external inputs via a network (LAN I/F 111 and WLAN I/F 109), one of these is selected and set as the interface to be validated in a sleep state (power saving state). Further, the present invention may also be configured so that when the image forming apparatus enters a sleep state, the CPU 101 controls the clock supply to the plurality of network interfaces (LAN I/F 111 and WLAN I/F 109) by stopping the supply of the clock to the interfaces other than the interface set to be validated in a sleep state. Based on this configuration, even when a plurality of network interfaces is connected to the image forming apparatus, power consumption can be reduced while enabling wake up via a desired network interface during sleep.

Although the present exemplary embodiment stops the clock supply as the sleep entry operation, obviously, from the perspective of reducing power consumption, the present exemplary embodiment can also employ other means. Examples of such other means may include dynamic voltage and frequency scaling (DVFS), which reduces power voltage and operating frequency.

Further, power saving can also be realized by stopping the clock supply to the power saving sections during sleep (CPU 101, ROM 102, RAM 103, UI unit 107, and printing unit 108) other than the interfaces (WLAN I/F 109, USB I/F 110, and LAN I/F 111). Moreover, the power supply to the power saving sections during sleep other than the interfaces may be stopped. In this case, configuring the power control based on one circuit for the power saving sections during sleep other than the interfaces can avoid a large increase in costs.

Further, when entering sleep, in step S408 of FIG. 4, a configuration was illustrated in which the clock supply to the CPU 101 etc. (CPU 101, ROM 102, RAM 103, and UI unit 107) is stopped. However, a configuration may also be employed in which the power supply to the CPU 101 etc. (CPU 101, ROM 102, RAM 103, UI unit 107 and printing unit 108) is cut off by providing a circuit capable of cutting off the power supply to these units collectively.

In addition, a configuration was described in which, among a plurality of interfaces (WLAN I/F 109, USB I/F 110, and LAN I/F 111), the supply of a clock to the interfaces other than the interface set to be validated in a sleep state (power saving state) is stopped. However, the present invention may be configured so that the supply of power to the interfaces other than the interface set to be validated in a sleep state is stopped. Additionally, the interfaces may be limited to only a network interface.

For example, the present invention may be configured so that, among the plurality of interfaces that receive external inputs via a network (LAN I/F 111 and WLAN I/F 109), one of these is selected and set as the interface to be validated in a sleep state. Further, the present invention may also be configured so that when the image forming apparatus enters a sleep state, the CPU 101 controls the power supply to the plurality of interfaces (LAN I/F 111 and WLAN I/F 109) by stopping the supply of power to the interfaces other than the interface set to be validated in a sleep state. Based on this configuration, even when a plurality of network interfaces is connected to the image forming apparatus, power consumption can be reduced while enabling wake up via a desired network interface during sleep.

Further, the present invention may be configured so that, without stopping the clock supply to the CPU 101, power consumption is suppressed by switching the CPU to sleep mode. The present invention may also be configured so that, without stopping the clock supply to the RAM 103, power consumption is suppressed by switching the RAM to a self refresh mode. Moreover, the present invention may be configured so that power consumption is suppressed by, if some other module also has a mode capable of suppressing power consumption, transitioning to that mode.

Still further, when “automatic selection” is selected and set as the standby I/F during sleep, the interface that the user last used was set as the I/F to be on standby during sleep. However, the present invention may be configured so that when “automatic selection” is selected and set as the standby I/F during sleep, the interface with the highest usage frequency may be set as the I/F to be on standby during sleep. The usage frequency may simply be the frequency of the interfaces used during a predetermined period, such as the most recent 1 week period, or may be the frequency of the factor triggering wake up from sleep in a predetermined period. The information about the interface usage frequency may be stored in a non-volatile memory in the I/F control unit 106. Alternatively, other non-volatile memory is provided to store the information in the non-volatile memory, and information about only the interface with the highest usage frequency may be stored in the I/F control unit 106.

As described above, even when a plurality of interfaces is connected to an image forming apparatus, power consumption during sleep can be reduced while enabling wake up via a desired network interface during sleep based on a simple yet inexpensive configuration in which the image forming apparatus enters sleep by supplying a clock only to an interface set as a standby interface during sleep, and stopping the clock to the other interfaces.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-041674 filed Feb. 28, 2012, which is hereby incorporated by reference herein in its entirety.

What is claimed is:

1. An image forming apparatus configured to enter a first power state in which power is supplied to a part of the image forming apparatus and a second power state in which power is not supplied to the part of the image forming apparatus, the image forming apparatus comprising:
a plurality of interfaces configured to receive external inputs via a network;
a display unit configured to display a screen for selecting an interface that becomes effective in a case where the image forming apparatus is in the second power state, from among the plurality of interfaces; and
a power supply unit, in a case where the image forming apparatus is in the second power state, configured to supply power to an interface that has been selected on the screen displayed by the display unit and configured not to supply a power to an interface that has not been selected on the screen.

2. The image forming apparatus according to claim 1, wherein the plurality of interfaces include USB interface, LAN interface, or WAN interface.

3. The image forming apparatus according to claim 1, further comprising an image forming unit configured to form image on a sheet,
wherein the part of the image forming apparatus is the image forming unit.

4. The image forming apparatus according to claim 1, further comprising a determination unit configured to determine whether the plurality of interfaces is connected to the image forming apparatus.

5. The image forming apparatus according to claim 1, wherein in a case where none of the interfaces has been selected on the screen, the display unit displays warning screen.

6. The image forming apparatus according to claim 5, wherein the warning screen indicates that there is little effect of power saving.

7. A method for controlling an image forming apparatus that comprises a plurality of interfaces configured to receive external inputs via a network and enters a first power state in which a power is supplied to a part of the image forming apparatus and a second power state in which a power is not supplied to the part of the image forming apparatus, the method comprising:
displaying a screen for selecting an interface to be used in the second power state from among the plurality of interfaces; and
supplying in a case where the image forming apparatus enters the second power state, power to the interface that is selected on the screen and not to supply power to a interface that is not selected on the screen.

8. A non-transitory storage medium on which is stored a computer program for making a computer execute each step in the control method according to claim 7.
